(19) United States
(12) Patent Application Publication
(10) Pub. No.: US 2026/0359867 A1
(43) Pub. Date: Nov. 12, 2026

(54) SYSTEM AND METHOD FOR AN ENHANCED CHOICE TOOL FOR CONSUMERS REGARDING TARGETED ADVERTISING

(71) Applicant: Digital Advertising Alliance, New Providence, NJ (US)

(72) Inventor: Luigi MASTRIA, Berkeley Heights, NJ (US)

(73) Assignee: Digital Advertising Alliance, New Providence, NJ (US)

(21) Appl. No.: 19/204,783

(22) Filed: May 12, 2025

(51) Int. Cl. G06Q 30/0251; G06Q 30/0273

(52) U.S. Cl. CPC G06Q 30/0269; G06Q 30/0275

(57) ABSTRACT

Systems and methods for an enhanced choice tool for consumers regarding targeted advertising. An advertising system includes choice tools for generating and applying user preference signals, in the form of a choice signal, across digital platforms. An extensible API or a choice extension enable access to and encoding of the choice string. Together, these tools enable privacy-focused advertising across fully authenticated as well as non-authenticated identity contexts.

### BACKGROUND

### 1. Technical Field

The present disclosure relates to digital advertising systems and methods, and more specifically, to a novel method/tool for capturing and broadcasting consumer choices regarding Interest Based Advertising (IBA) or Targeted Advertising.

### 2. Technical Background

Digital advertising, such as IBA, has seen significant changes recently in data practices, largely due to privacy concerns and regulations. Firstly, increased regulation from privacy laws in the United States and other laws in other countries or regions have imposed rules and regulations on how companies can collect and use personal data for advertising purposes, which has led to a greater emphasis on transparency and user choices. Secondly, many browsers have begun phasing out third-party cookies, which have traditionally been a primary method for tracking user behavior across the web. This change challenges advertisers to find new ways to gather insights about user interests while still providing transparency and control. Thirdly, as reliance on third-party cookies diminishes, advertisers are increasingly focusing on alternative identifiers. Fourthly, industry-led initiatives to provide consumers with transparency and control about data collection and use with new identifiers continue to complement or supplement new/emerging laws.

These changes reflect a broader shift in the digital advertising landscape, aiming to address user privacy while still aiming to deliver relevant advertisements. To this end, alternative technologies and frameworks are being developed to facilitate interest-based advertising while providing privacy awareness and control tools.

### SUMMARY

The present invention features a system, method, and computer program product that, in an exemplary embodiment, provides an enhanced opt-out tool for consumers regarding IBA, also known as Online Behavioral Advertising (OBA) and sometimes referred to as Targeted Advertising based on identifiers which are not only cookies. This tool allows consumers to effectively set choices and/or revoke prior consent and manage their advertising preferences for multiple identifier types. Moreover, integrated into the tool is the ability to surface categories of interest from which consumers may choose to express interest or limit interest.

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Disclosed are choice tools which provide a technical solution to the technical problem described. A method for performing the concepts disclosed herein can include: receiving a user identification (ID) of a user through an activity of the user on a publisher platform, wherein the user ID is a hashed email or a hashed phone number; transmitting the user ID via a request to an API, wherein the API is an extensible API; retrieving a choice signal associated with the user ID compiled via the API, wherein the choice signal indicates one or more choices and/or preferences of the user; receiving a bid request, from the publisher platform, to display an ad to the user by at least one advertiser; identifying, by the at least one advertiser, the one or more choices and/or preferences of the user based on the choice signal; determining a bidding strategy in response to the bid request based on the identification; and displaying the ad on the publisher platform to the user in accordance with the bidding strategy.

A method for performing the concepts disclosed herein can include: detecting an activity of a user on a publisher platform using a browser, wherein the browser comprises a choice extension; retrieving, from the choice extension, a choice signal associated with the browser, wherein the choice signal indicates one or more choices and/or preferences of the user; receiving a bid request, from the publisher platform, to display an ad to the user by at least one advertiser; identifying, by the at least one advertiser, the one or more choices and/or preferences of the user based on the choice signal; determining a bidding strategy in response to the bid request based on the identification; and displaying the ad on the publisher platform to the user in accordance with the bidding strategy.

A method for performing the concepts disclosed herein can include: receiving one or more choices and/or preferences related to advertisement from a user; compiling, via an extensible API associated with a first system, the one or more choices and/preferences into a choice signal, wherein the choice signal comprises an opt-in action for a first advertiser and an opt-out action for a second advertiser; transmitting the choice signal to the first system and a second system, wherein the second system is associated with a publisher platform; receiving a user identification (ID) of the user through an activity of the user on a publisher platform; retrieving the choice signal associated with the user ID from the first system; determining that the choice signal is not stored in the first system; retrieving the choice signal from the second system; transmitting the choice signal to an ad tech party, wherein the ad tech party blocks the second advertiser based on the opt-out action of the choice signal.

### BRIEF DESCRIPTION OF THE DRAWINGS

FIG. 1 illustrates a block diagram of an exemplary embodiment outlining the flow of user choice/preference data in an advertising ecosystem using the Choice Signal;

FIG. 2A illustrates a diagram of an exemplary embodiment of a format of a choice string inside the choice signal;

FIG. 2B illustrates an exemplary URL that transmits user choice/preference data which can be encoded in the choice signal within the advertising ecosystem;

FIG. 3 illustrates a diagram of an exemplary embodiment of an example choice string encoding the user's choice/preference data;

FIG. 4 illustrates an exemplary embodiment illustrating a process of retrieving the user's choice and preferences information using the choice browser extension when the user visits a website through a browser;

FIG. 5 illustrates an exemplary embodiment of a Consent Management Platform (CMP) and an icon of the choice tool hosted by the CMP;

FIG. 6 illustrates an exemplary user end interface that enables a communication of network-wide user privacy/preference data;

FIG. 7 illustrates an exemplary embodiment that continues to illustrate the user end interface that enables a communication of network-wide user privacy/preference data;

FIG. 8 illustrates an exemplary embodiment illustrating a process of retrieving the user's choice and preferences information using the choice string where the brand or publisher has provided the token to a consent management platform or other platforms to identify the appropriate user choice string; and

### DETAILED DESCRIPTION

Various embodiments of the disclosure are described in detail below. While specific implementations are described, this is done for illustration purposes only. Other components and configurations may be used without parting from the spirit and scope of the disclosure.

Embodiments of the invention provide an extensible API for user preferences for communicating the preferences between two or more parties, for example, from a consumer, through the choice platform, and to an advertiser's ad technology partner. Embodiments of the invention also provide a choice signal encoded by the extensible API. In some embodiments, the choice signal may also by encoded by other tools, such as a choice extension, as will be discussed below related to figures. By providing both tools (API and choice signal) to the advertising ecosystem, marketers can provide privacy-focused choices in fully authenticated (e.g., hashed email, etc.), under-authenticated (pseudonymized, etc.), and non-authenticated (IP targeting, etc.) use cases.

In some embodiments. the extensible API is designed to dynamically accommodate different identifier types by allowing for the addition of new values and features without disrupting existing consumer functionality. An important aspect is the ability to use a parametrizable API to collect and transmit consumer privacy preferences. This functionality allows the system to package granular privacy preferences in a structured format that can be accessed via other APIs, browser extensions, or alternative methods, ensuring broad compatibility across various platforms and technologies. Advantageously, the extensible API can easily integrate updates, such as new interest categories or consent protocols of users, while supporting multiple versions to maintain backward compatibility. This may be accomplished by utilizing a structured specification as will be described in the following specification. This flexibility ensures that as user preferences and industry practices evolve, the extensible API remains relevant and effective in delivering tailored advertising experiences. Additionally, the API enables efficient retrieval and transmission of user consent choices, empowering both users and advertisers in the digital landscape.

In some embodiments, the extensible API may deliver three main parameters below through an extensible signal:
Identifier Type (idt): A signal alerting the recipient which identifier will follow (e.g., phone number, etc);
Action (action): The specific action taken by the user or consumer (e.g., opt-out, etc);
Preferences (pref): A string representing the user's selected category/interests; Additional parameters delivered by the extensible API can include timestamp and version numbers, among others.

In some embodiments, additional parameters other than the three main parameters above are also contemplated. As an example, a fourth parameter may indicate position information of a user. Each parameter of the above three main parameters may take different values, depending on different choices made by different users. For example, parameter idt stands for identifier type and may be an email, a phone number, or other identifier type of the user. As for parameter action, it may be set to opt-in, opt-out, revoke, or other actions taken by the user when making a choice regarding IBA. The third parameter pref stands for preference string and is used to set user-requested category preferences. Some example categories of user preferences may be set to Automotive/Careers/Culture, and so on based on a curated list from thousands of categories and subcategories used by industry to target audiences. This decoding of categories and subcategories may be based on a CDN-based service which permits end-users to systematically search and identify category signals. Additionally, each category of user preferences may further be divided into a number of subcategories. As an example, the Automotive category may consist of Auto Body/Auto Buying and Selling/Auto Rental, and so on.

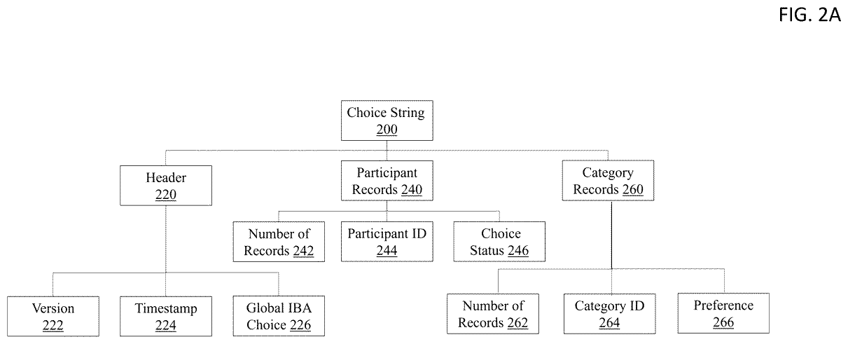

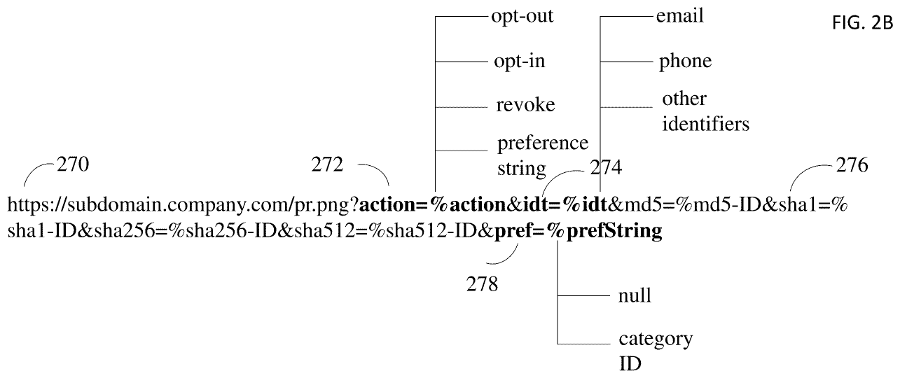

In some embodiments, the values of these three main parameters are designed to be extensible. With the aid of the extensible API, the new choice tool not only allows for the user to opt-out or revoke consent, but also enables the ability to surface categories of interest to the users as described above. The user may choose to opt out of data collection and use for IBA, or to limit advertising of certain categories, or be served ads based on the consent and selected categories, or only receiving ads in the selected categories, among other things. In fact, the simplicity of the API also permits for future new parameters to be added without major disruptions to the existing functionality. More detailed discussion on the choice signal that communicates the user choice/preferences encoded in the choice signal to backend servers, such as publishers or ad tech servers, are described in relation to the description of FIG. 2A and FIG. 2B.

In some embodiments, the choice tool may include tools for tokens and tools for other types of identifiers, such as cookies, device IDs, or mobile advertising identifiers that can be used to track users for advertising purposes. For example, the choice app which allows users to manage their privacy preferences on mobile devices uses the same API as the token tool for transmitting mobile advertising identifiers to ad technology companies from consumers.

The token tool focuses on managing user choices and preferences. Specifically, the token tool provides the identifier type (idt) for users and allows companies to receive and interpret user actions (action) tied to the identifier passed in the parameters. For example, the user action may be interpreted to be opting out a mobile ad with company ID 123. The category tool complements the token tool by enabling users to specify their interests in a more granular way—thus enabling consumers to limit specific categories of advertising/content instead of opting out altogether. Specifically, it presents consumers with a simplified list of interest categories related to digital advertising. Similar to the token tool, the category tool transmits/makes available user preferences (as a string of selected categories) to participating companies. This enables these companies to tailor their advertising/content to match user interests. Advantageously, the token tool uses the same extensible API as the category tool.

In some embodiments, using a common API for the token tool and the category tool enables both tools to share a consistent format for transmitting information, such as user identifier types (idt), actions (action) and preferences (pref), which simplifies adoption, data processing and management. In addition, when both tools operate under the same API, the user's transition between expressing choices (via the token tool) and specifying interests (via the category tool) becomes more intuitive, as they interact with the same underlying system. Moreover, with a shared API, it becomes easier to add new features or make changes in the future. If enhancements are needed for how user preferences are managed or if new tools are introduced, they can be built upon the existing framework without requiring significant alterations.

In some embodiments, there are a number of potential extensibility options leveraging the extensible API for the choice tool. A choice extension is a browser-based extension that stores the choice string and makes it available at the browser level. Companies can access this extension to determine the choice status, category preferences, or legally mandated consent status(es) of users, among other things. This enables users to request an opt-out of the collection and use of their personal information with a single action across multiple websites. As another example, a widget can provide a user-friendly interface for consumers to manage their privacy preferences directly within mobile applications. This can ensure compliance with privacy laws such as California's CCPA and allow users to exercise control over their data within app environments.

It is important to note that the choice string can be accessed by companies in different modalities. For example, companies can choose to receive the choice string via an API integration and/or choose to read it via the choice extension, among other modes.

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

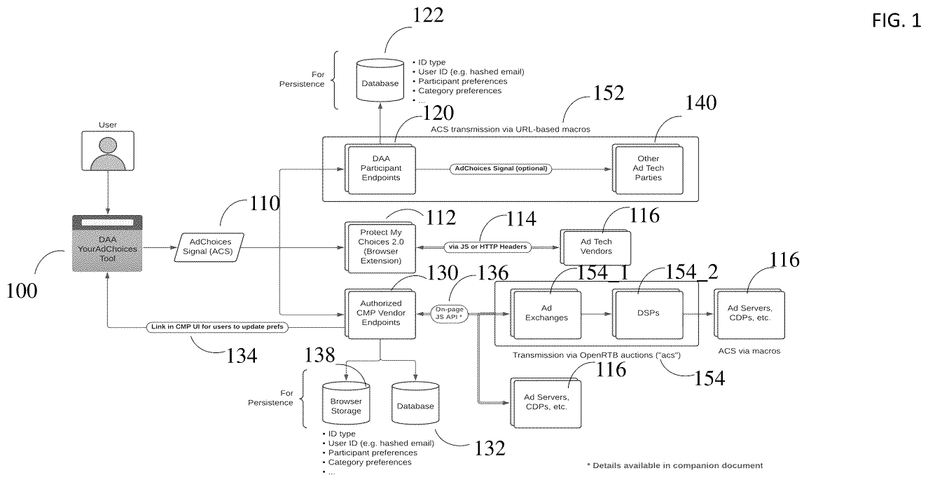

FIG. 1 is a block diagram of an exemplary embodiment outlining the flow of user requests, in the form of a choice signal 110, in an advertising ecosystem. When a user visits the choice tool 100, their requests, e.g., opting in or out of targeted advertising, choosing specific categories of interest or categories to limit, are collected. These choices are encoded into the choice signal 110, which is generated by the choice tool 100. The choice signal 110 may be associated with an identification of user, such as a hashed email. Other identification types or in some cases, no identification type is also contemplated, as will be described in relation to a choice extension 112. The choice signal 110 is a structured piece of data that may include different types of user privacy information, such as:
Ad preferences (e.g., opted-in or opted-out of targeted ads, etc.)
Category preferences (e.g., preferences for certain types of ads or specific ad categories the user wants to limit)

The generated choice signal 110 is then received by an endpoint. The endpoint can be a system or a URL that serves as a receiving point for the choice signal 110 in a network. As illustrated in FIG. 1, the choice signal 110 may be transmitted through various endpoints within the advertising ecosystem, such as through the choice extension 112, a participant 120 of the choice tool 100, or an authorized Content Management Platform (CMP) vendor endpoint 130. It should be appreciated that these paths are illustrative examples and are not exhaustive of all possible transmission modalities.

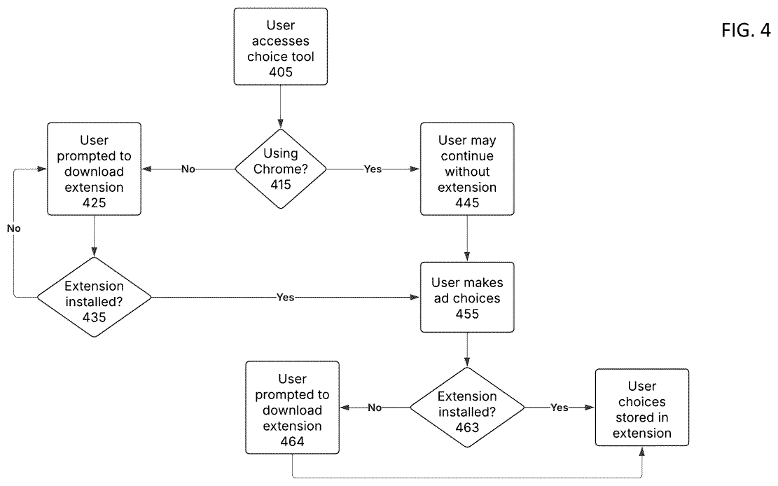

A first path for transmitting the choice signal 110 is through the choice extension 112, which may act as a privacy-preserving database stored within the user's browser. When users install the choice extension 112 (the process of which will be discussed later in relation to FIG. 4), their preferences regarding ad targeting (e.g., opting out of specific companies or categories) may be stored within the choice extension's 112 local database.

It should be appreciated that the choice extension 112 may not transmit any personally identifiable information. The choice extension 112 may only communicate the choice signal 110 in a non-identifiable format, that is, no hashed email or other personal identifiers are included in the choice signal 110 transmitted by the choice extension 112. While the choice extension 112 does not directly transmit personal identification information, it acts as a proxy by relaying privacy preferences and choices that are tied to a specific user, enabling ad tech vendors and publishers 116 to process these preferences in a way that indirectly reflects the user's identity without revealing personal details. This design ensures privacy as the choice signal 110 transmitted by the choice extension 112 does not tie back to the individual user.

The choice signal 110 may then be transmitted to various ad tech vendors, such as ad servers, customer data platforms (CDPs), and other systems 116 via a JavaScript API 136 running on the webpage and/or HTTP Headers, interrogation of the extension or other means. This is a direct way for the user's preferences to be shared with the relevant ad technologies. Advantageously, any ad tech vendor or publisher 116 may access the choice signal 110 stored within the choice extension 112's local database in real-time, thus always respecting the user's preferences. In the first path, the choice signal 110 may be transmitted via various routes, such as a JavaScript API or a HTTP Header 114. If the website that the user visits support JavaScript 114, then the choice extension 112 may expose an event listener on the webpage. Then, the ad tech vendors 116 may query the choice extension 112 via this listener to retrieve the choice signal 110 directly. If JavaScript is unavailable or the ad vendor 116 prefers a non-JavaScript method, the choice signal 110 may be transmitted via an HTTP header 114 which may be accessible to any intermediary or ad tech vendor 116 reading the request.

As a second path, the choice signal 110 may be transmitted to various at tech parties 140 through participant endpoints 120. The second path involves the use of the URL-based macros 152 and may also accommodate the transmission of user's personal identifier such as hashed emails, which is different from the path through the choice extension 112, when the authorized participants 120 provide a secure endpoint for sending the personal identifier to.

In the second path, the choice signal 110 may be transmitted via URL-based macros 152. The URL-based macros 152 are placeholders with a URL that are dynamically replaced with user data, e.g., the choice signal 110, allowing the choice signal 110 to be transmitted to various ad tech parties 140. For instance, the URL in an ad request may take the form of:
<scriptsrc=“https://ads.ssp.com/jstag?pid=18504&sid=955917&plid=7821315&sz=300×250&adchoices_signal=[STRING_HERE]”></script>

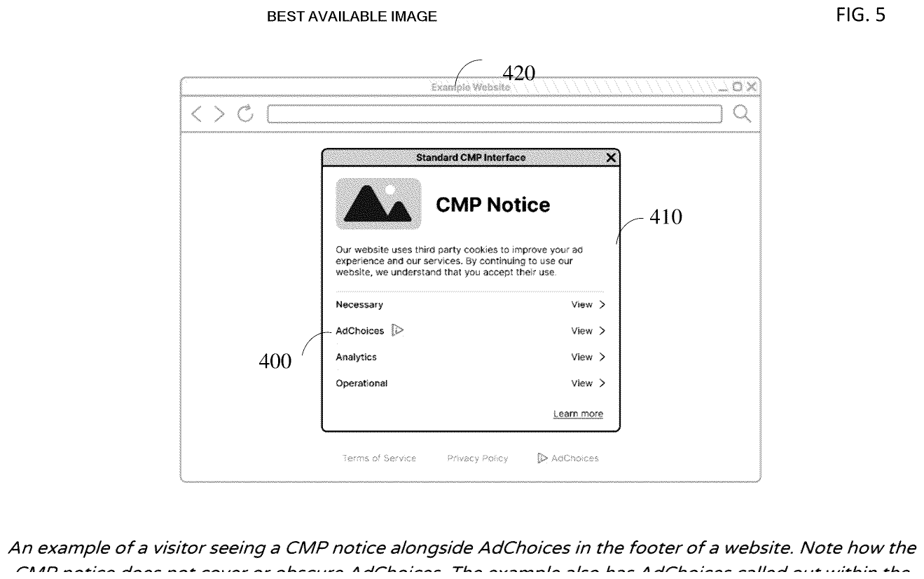

As a third path, the choice signal 110 may be transmitted to ad tech vendors or publishers 116 via an authorized Content Management Platform (CMP) vendor endpoint 130. The CMP is a system that helps websites manage user consent and preferences regarding data collection, often in compliance with privacy regulations such as GDPR. The authorized CMP vendor endpoints 130 refers to the services provided by certified CMP vendors that can access, transmit or receive data related to user consent or preferences. These vendors are authorized to interact with the choice tool 100 and may provide a user interface for users to manage their preferences, which will be discussed in more details related to the description of FIGS. 4 and 5. Preferably, the authorized CMP vendor endpoints 130 may also generate a link 134 in the CMP User Interface for users to update their preferences, which is received by the choice tool 100.

In the third path, the choice signal 110 may be passed as part of the auction process in the case of real-time bidding (RTB) 154. RTB 154 is used by ad exchanges 154_1 to facilitate the automated buying and selling of ad spaces in real-time. The choice signal 110 can be embedded in these transactions to ensure that the user's preferences are taken into account during the ad buying process. For example, a user may visit a publisher, such as a website or a mobile app that participates in RTB 154. The ad exchanges 154_1, which facilitates an auction process between an advertiser and the publisher, may then receive a bid request from the publisher. The bid request may have access to the choice signal. In some embodiments, a bid request may include the choice signal 110, and other attributes, e.g., the user's device type, and browsing contex, which are embedded in the bid request. In some embodiments, the bid request may access the choice signal 110 through reading from the choice extension 112. The advertiser, such as a demand-side platform (DSP) 154_2, may receive the bid request and analyze the choice signal 110. In some embodiments, the user has opted in to receive ads from some advertisers and opted out to receive ads from some other advertisers. If the advertiser is opted out, the DSP 154_2 may not place a bid, or the ad exchanges 154_1 may filter the advertiser out before bidding, such that only opted-in advertisers may compete in the auction. In some embodiments, the user has allowed for certain ad categories and limited some other ad categories. For example, suppose the user has previously indicated that they do not wish to see targeted ads related to automotive products. The advertiser may read the choice signal 110 and determines whether their available ad inventory aligns with the user's preferences encoded in the choice signal 110. For example, if the advertiser only has automotive-related ads available, they may choose not to place a bid to respect the user's preference. If the advertiser has other ad categories, such as technology, or travel, the ad bidders may adjust their bid accordingly and compete to display a relevant ad. Once the auction concludes, the highest ad bid from the advertiser that complies with the choice signal 110 may win the opportunity to display the ad. In this way, the choice signal 110 may ensure that the user's choice/preferences are respected dynamically within the RTB 154 process.

Once the choice signal 110 is transmitted to the relevant participants endpoints 120 or authorized CMP vendor endpoints 130, it is typically stored in databases for persistence. As illustrated in FIG. 1, the participants endpoints are connected to a first database 122. The authorized CMP vendor endpoints 130, in addition to be connected to a second database 132, is also connected to a website storage 138. In this way, the user's preferences, such as ID type, user ID (e.g., hashed email), participant preferences and category preferences, are saved and can be accessed later. The endpoints 120, 130 can be connected to both a long-term storage and a short-term storage. The difference is that data saved in the long-term storage, such as a database 122 or 132, remains available and accessible even after the system restarts or the user returns later, whereas the data stored in the short-term storage, such as a web browser 138, is used to remember user preferences across different sessions or visits to websites on which the same CMP operates. This is contrasted with storage in, for example, choice extension 112, which allows access to the choice signal 110 (e.g., via interrogating the extension, or via an Xchoices header, etc) on every website traversed by the user on that browser.

Although the above discussion on the flow of user requests in the form of a choice signal 110 in FIG. 1 is discussed in connection with web/mobile environment, the choice signal 110 may be transportable and interpretable across any system capable of ingesting, storing, and respecting consumer preferences. In some embodiments, a non-browser system, such as a connected TV can ingest the choice signal 110 by leveraging existing transmission paths described herein. As an example, the connected TV may serve as authorized participants 120 themselves to initiate the choice signal 110 transmission via URL-based macros 152 to ad tech vendors 140 in the connected TV ad delivery chain. As another example, the connected TV can instead integrate with an authorized CMP vendor, using the CMP's secure endpoint 130 to retrieve or manage choice signal 110 on the user's behalf. In some embodiments, non-browser systems that can transport and interpret the choice signal 110 may further includes gaming consoles, set-top boxes, or IoT devices.

FIG. 2A is a diagram of an exemplary embodiment illustrating a format of the choice signal 110. The choice signal 110 is a sequence of bits, representing a series of sections, in big-endian format. It may be transmitted as a base64url string. This encoding ensures an approach that is consistent with other such strings currently in use across the ad tech industry. All numeric values are unsigned integers. As illustrated in FIG. 2A, the choice string 200 may include multiple sections, such as a header section 220, a per-participant record section 240, and a per-category records section 260.

The header section may include three key fields: a version number field 222, a timestamp field 224 representing the creation time in seconds since the Unix epoch, and a global IBA choice status field 226, which indicates whether the user has limited, allowed, or expressed no preference regarding data collection for IBA. Different values may be assigned to each bit which represent different statuses. For example, a global choice status of 0 means the user has opted to limit data collection, 1 means they have opted to allow it, and 2 indicates no preference. The bit length of each field may be determined based on a specification of the choice signal 110. As an example, the version number field 222 may have 6 bits. The timestamp field 224 may have 32 bits. The global IBA choice status field 226 may have 4 bits.

Following the header section 220 is the per-participant records section 240, which starts with a 12-bit field indicating the number of participant choice status records 242. Different values may be assigned to each bit which represent different statuses. For example, a value of zero in this field may indicate that there is no per-participant choice status record, and the next field will contain the per-category preference data 260, as will be described next. If present, each participant record 240 includes a 12-bit participant ID 244 and a 4-bit choice status 246, where 0 means the user has opted out, 1 means the user has opted in, and 2 signifies no preference. It should be noted that the per-participant records 240 are only included when the global IBA choice status 226 is set to 2, as the global setting applies to all participants. Likewise, records of a participant 240 with a choice status of the participant 246 being 2 is excluded, as they provide no actionable data.

Another section is the per-category preferences section 260, which begins with a 12-bit field indicating the number of category preference records 262. Each per-category record 260 may include a 12-bit category ID 264 and a 4-bit preference 266. Different values may be assigned to each bit which represent different statuses. For example, 0 means the user wants to limit ads in that category, 1 means the user allows ads in this category, and 2 means no preference. Records of categories with a preference 266 of 2 are excluded, as they provide no actionable data.

As illustrated in FIG. 2A, the choice signal 110 specification may be designed to be highly extensible, allowing for the addition of new fields or sections as needed in future updates without disrupting compatibility with existing systems. The extensibility of the choice signal 110 comes from its flexible structure, which allows for additional fields or modifications without disrupting its core functionality or compatibility with existing implementations. Advantageously, this extensibility may be achieved through the following five design elements in accordance with the example choice signal format shown in FIG. 2A.

The first design element is the modular structures with sections. In the example choice signal format, the choice signal 110 is divided into distinct, logically structured sections, each of which may handle a different type of data (e.g., header 220, per-participant records 240, per-category preferences 260). This modular approach allows for individual sections or fields within those sections to be extended or modified independently. For example, if a new field or type of data needs to be added (e.g., additional user preferences, new participant data, or new identifier, etc.), it can be incorporated into the specific section that represents this field or type of data, without requiring a change to the entire signal format.

The second design element is the optional fields and records. Many of the fields in the signal format are conditional or optional. For instance, the “number of per-participant records” field controls the inclusion of participant-specific data. If there are no participant records, this field 242 may be set to zero, and the signal may skip over this section. This allows the format to adapt dynamically to different use cases—if no participant or category data is needed, those sections can be omitted, and additional fields or records can be added without disturbing the overall structure.

The third design element is the fixed-sized and variable-length encoding. While for some fields (like the version number 222, timestamp 224, and global status 226), it may be desirable to have fixed sizes (e.g., 6 bits for version number 222, 32 bits for timestamp 224), other sections (such as the participant 240 and category preference 260 records) may use length indicators (e.g., 12-bit counts) to specify how many records follow. These counts can be adjusted based on the number of records, which means the number of participant 242 or category 262 records may be expanded without altering the fixed structure of the signal 110 itself. The flexibility comes from the use of these dynamic-length sections, which can grow or shrink depending on the data being encoded.

The fourth design element is the versioning mechanism. The version number 222 (6 bits) allows the format to evolve over time. For example, if a new version of the specification introduces new fields or alters existing ones, the version number 222 can be incremented. This version number 222 helps receivers of the choice signal 110 interpret it correctly, knowing which version of the specification to apply when parsing the signal. Older versions of the signal 110 can be still processed by systems that understand previous versions, ensuring backward compatibility.

The fifth design element is the bit allocation. For the current version of the choice signal 110 specification, the bit-length of each field is predetermined, but there's room within the structure for future expansion. For example, while the 12-bit participant ID field 244 may be sufficient for the current specification, it could be extended in a future version if more participant IDs are needed. The length of certain fields like the participant ID 244 or category ID 264 could be increased in later versions (e.g., extending a 12-bit ID to 16 bits) as long as the parsing logic is updated to handle the new bit lengths, and new fields could be inserted where there are gaps (e.g., in the header 220 or per-category section 260).

Another example that illustrates the extensibility of the API which permits for future new parameters to be added without major disruptions to the existing functionality is provided in FIG. 2B. FIG. 2B illustrates an exemplary URL 270 for a user flow, which may involve a sequence of steps that the user takes to manage their advertising preferences for a particular company with a participant ID 244 that integrates the choice tool 100. Exemplary user flows will be further discussed in relation to FIGS. 4-8. Within the user flow, the URL 270 may serve as a key part of how preferences are transmitted between the user, the choice system 100, and the ad network such as ad tech vendors 116 and other ad tech parties 140. As one example, the URL 270 may trigger the user flow. When a user interacts with the choice tool 100, the action often results in a request that leads to the URL 270. The URL 270 serves as the pathway for transmitting the user's choices or preferences to the backend systems that manage advertising. As another example, the URL 270 may be used to convey user preferences. Once the user has made their choice, the choice system 100 may use the URL 270 to transmit that decision to relevant servers such as relevant participant endpoints 120 as illustrated in FIG. 1, among other methods of transmission.

The URL 270 in FIG. 2B includes parameters that may map directly to the choice/preferences stored in the choice string 200 in FIG. 2A. As shown in FIG. 2B, the URL 270 contains multiple necessary parameters that reflect the user's choice/preferences. Specifically, the example URL 270 is structured with parameters 272-278 that capture the user's choices and identifiers. The action=%action 272 specifies what action the user has chosen, such as “opt-out” or “revoke consent”. The idt=%idt 274 is a unique identifier that links the user to the choice they have made. The md5, sha1, sha256 and sha512 276 are different hashed representations of the user ID or other identifying data. The pref=%prefString 278 represents the specific preferences the user has set, such as which interest categories they want to enable or limit.

Advantageously, the extensible API would allow for new parameters, methods or endpoints added to the URL 270 in a modular and scalable way. The following examples illustrate how the modular architecture and scalability of the API permits for new parameters or endpoints to be added to the URL 270.

The modular architecture of the extensible API makes sure that each parameter and feature is decoupled from others. For example, a previous version of the URL 270 may only allow a user to opt out or revoke consent 272 of a company. Now also integrated into the user flow is the ability to surface categories of interest among users, denoted by a pref string 278. To this end, a new handler can be added to the extensible API specifically for handling the preference data, while the existing handlers for action 272 and idt 274 continue to operate as before. The new parameters, such as pref 278, may be introduced and processed in a new, separated function or method that does not interfere with the existing parameters.

As future new features are needed, the extensible API may scale by expanding existing parameters. Instead of creating completely new parameters, existing parameters can be updated to accept new values as optional, non-breaking additions. For example, a parameter like idt 274 may be expanded to accept new optional values like address or AMI, while still maintaining backward compatibility with the older values.

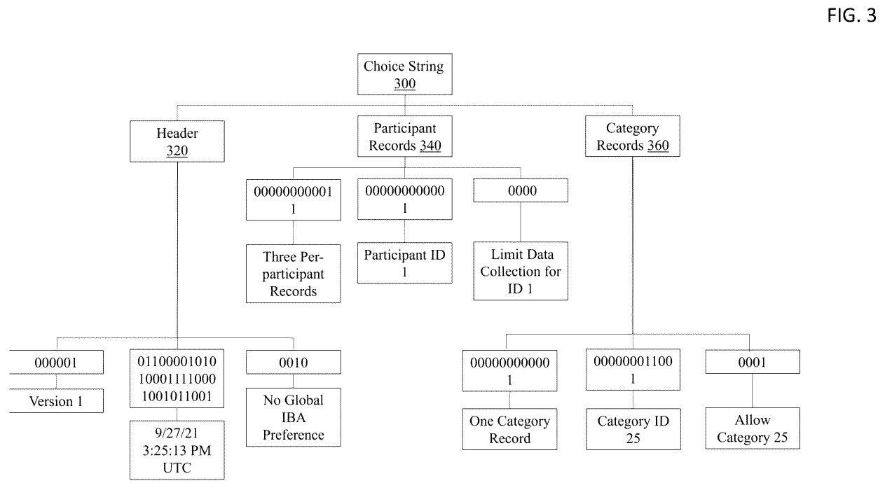

FIG. 3 illustrates an example string representation 300 of the choice signal 110 in accordance with the choice signal format described in FIG. 2A. The graph shows a complete annotated breakdown of a sample binary string. It should be appreciated that the following decoding of the sample binary string is only presented for illustrative purposes. In practice, the decoding of the binary string may vary from the decoding in FIG. 3. The values of each field are in binary representations. Specifically, within the header section 320, the value of the version field is 000001, corresponding to a version 1 of the choice signal specifications, since 000001 is the binary representation for the number 1. Likewise, the value of the timestamp field is 01100001010100011110001001011001, corresponding to 1632756313 seconds since epoch, which converts to Monday, Sep. 27, 2021, 3:25:13 PM UTC. The value of the global IBA choices status is 0010, corresponding to a choice status of 2, meaning that the user has explicitly expressed no preference regarding IBA.

Next, within the per-participant records section 340, the value of the number of per-participant records is 000000000011, corresponding to a presence of three per-participant records. Further, within the per-participant choice status records, the value of the participant ID of the first participant is 000000000001, corresponding to participant ID 1. The value of the choice status is 0000, corresponding to a participant's choice status of 0, meaning that the user has explicitly chosen to limit data collection and use for IBA for the participant with ID 1.

Likewise, the value of the choice status of the participant with ID 2 (not shown) is 0001, corresponding to a participant choice status of 1, meaning that the user has explicitly chosen to allow data collection and use for IBA for the participant with ID 2. The value of the choice status of the participant with ID 3 (not shown) is same as that of ID 1, meaning that the user has also explicitly chosen to limit data collection and use for IBA for the participant with ID 3.

Next to the per-participant choice status records is the per-category records section 360. Within the per-category records section, the value of the number of per-category records is 000000000001, corresponding to 1 per-category record. Further, within the per-category preference records, the value of the category ID is 000000011001, corresponding to a category ID 25. By referring to a category reference file, which assigns each category with a number, ID 25 currently represents the category “Travel”. The value of the category preference is 0001, corresponding to a user preference of 1, meaning that the user has explicitly chosen to allow advertising in the “Travel” category.

As illustrated above, the example binary string 300 of the choice signal 110 represents a single global preference of no preference, three participants' choices (one opted in, the other two opted out), and one category choices (the user opted in for advertising in the “Travel” category). It should be noted that this example binary format may be extensible, meaning new records could be added (more participants or categories) by following the same format. As an example, four participants records can be denoted as 000000000100, or a category ID of 30 could represent the category “Sports”.

As described previously in FIG. 1, the choice signal 110 may be received by a choice extension 112, an authorized CMP vendor endpoint 130, Participant Endpoints 120, or via other modalities. Once received, the choice signal 110 can then be passed to multiple sites and apps to ensure that the user's preferences are communicated and respected across all the systems that handle the user's data. The following figures FIG. 4-7 illustrate two exemplary user flows when the choice signal 110 are received by different modalities. In particular, FIG. 4 illustrates the user flow via the choice extension 112 and FIG. 5-7 illustrates the user flow via the authorized CMP vendor endpoint 130.

FIG. 4 illustrates two scenarios of user flow. At step 405, the user visits a website via a Chrome browser. At step 415, if the browser is a Chrome browser in accordance with a first scenario, then the user at step 445 may access the choice tool 100 on the website without needing to have the choice extension 112 installed on the browser. This is because the choice tool 100 may use first-party cookies on Chrome to temporarily store the user's choices/preferences. After the user makes their choices/preferences at step 455, the user is prompted to download and install the choice extension 112 at step 464 if the choice extension 112 is not already installed, as detected at step 463. Once installed, the choice extension would store the user's choices/preferences and an ad tech company would be able to access these choices/preferences through the choice extension 112 whenever this information is available. Back at step 415, if the browser is a non-Chrome browser in accordance with a second scenario, then the user intending to use the choice tool 100 when visiting the website would be required to install the choice extension 112 first at step 425. This is because a non-Chrome browser do not support third-party cookies in the same way as the Chrome browser, so that the choice extension 112 is required to store user choices/preferences. Once it is determined at step 435 that the choice extension 112 is installed, the future user flows would follow the steps in the first scenario.

FIGS. 5, 6 and 7 show an exemplary user end interface that enables this communication of network-wide choices. In particular, FIGS. 5, 6 and 7 show an exemplary embodiment illustrating the CMP 410 and a choice icon 400 hosted by the CMP 410. The choice icon 400 may act as the user interface to allow users to interact with and manage their advertising preferences, which are encoded as the choice signal 110. Conventionally, the CMP 410 alone could only offer users the ability to manage their consent for data collection and processing within a particular digital property, such as a site-specific consent notice. Advantageously, by incorporating the choice icon 400 with the CMP 410, companies can provide not only site-specific consent notices but also broader, network-wide choices which require the choice signal 110.

As illustrated in FIG. 5, the choice icon 400 may be placed in the footer of a website or within the “hamburger” menu of an app and may serve as a direct link to a dedicated choice interface within the CMP's larger user interface 410. This integration ensures that users can access a consistent, harmonized experience for managing both IBA and other privacy-related choices. This enhanced notice linking to the choice interface should not be obscured or hidden within the CMP experience, ensuring that users can always interact with it easily. For example, when a CMP notice appears on a website, it should not cover or hide the choice icon 400, ensuring both elements are visible and functional.

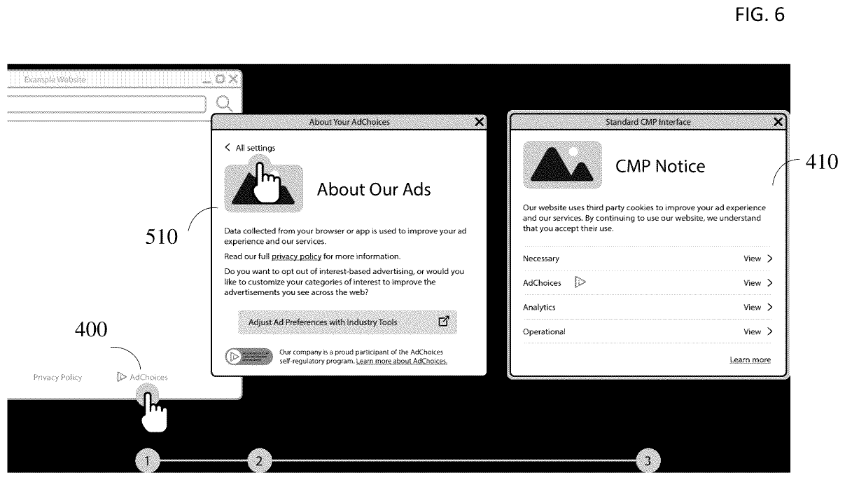

As illustrated in FIG. 6, the choice icon 400 may also play a critical role in prompting or re-prompting users to revisit their cross-site or other advertising choices. As an example, when a user clicks on the choice icon 400, they may be taken to a dedicated choice interface 510 where they can manage their preferences related to IBA, as well as make other privacy-related choices. From this interface 510, users can navigate into the broader CMP 410 settings if desired, allowing them to access both network-wide advertising controls and site-specific preferences in one seamless experience. The choice icon 400 may serve as a continuous reminder to users about where to manage their broader privacy choices, complementing the more frequent CMP notices or banners that may appear during a user's visit to a site or app.

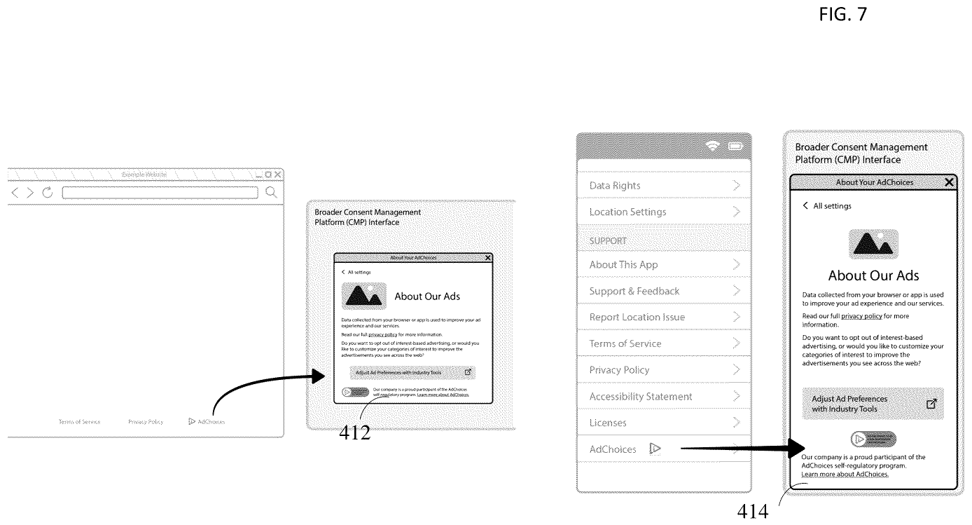

As illustrated in FIG. 7, some CMPs 410 will use the choice icon 400 to direct users who have interacted with a CMP notice to a specific section 412 in a website setting and 414 in an app setting within the CMP interface that focuses on relevant advertising practices and choices. This section 412 may be distinct from areas dedicated to other purposes, such as cookie or measurement-related practices. Additionally, the CMPs 410 can leverage the choice signal 110, which transmits users' choices completed through the choice tool 100. This signal allows CMPs to persist and/or display user choices across their network of sites and apps. If the choice signal 110 is found, the CMP 410 can display the signal's status within the choice interface 412 and 414, ensuring that user preferences are effectively communicated and respected across digital properties. This integration allows CMPs 410 to not only meet the guidelines of the choice tool 100 but also provide users with enhanced transparency and control over their advertising choices, both on a site-by-site and network-wide (cross-site) basis.

When a user interacts with the choice icon 400, which may be hosted within the CMP interface, a CMP's proprietary API 750 is responsible for retrieving and processing the choice signal that reflects the user's advertising preferences. In this sense, the CMP's proprietary API 750 plays a crucial role in linking the choice icon 400 and the choice signal 110, enabling seamless integration of user preferences across multiple digital properties.

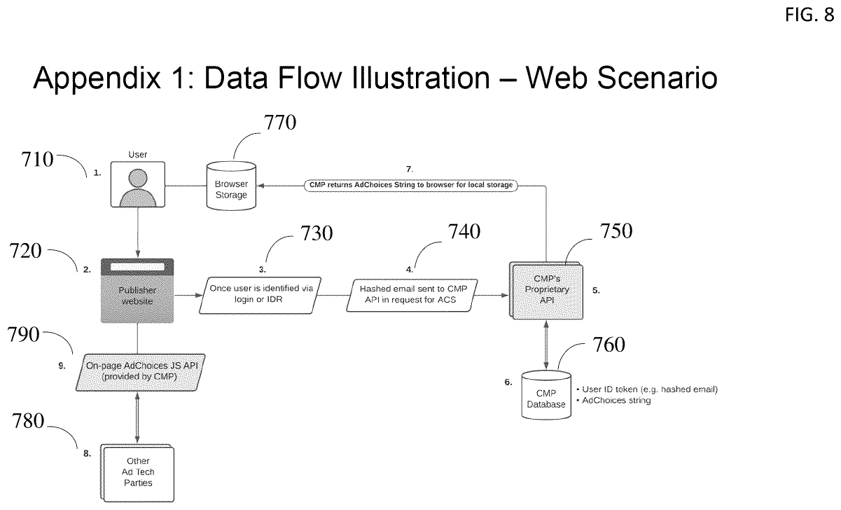

FIG. 8 is an exemplary data flow illustrating how the CMP's proprietary API 750 allows for a centralized management of limited network choices, making sure that the user's preferences are respected across all sites and apps within the CMP's own network. It should be noted that the data flow in FIG. 8 may in some examples correspond to an expanded illustration of an interaction between the choice signal 110 and the authorized CMP vendor endpoints 130 in FIG. 1.

Initially, the user 710 accesses and logs into a platform that displays digital contents, such as a publisher website 720 as illustrated in FIG. 8. Here, logging in may involve providing username/password or other methods. Then, the user may be identified either through a login system or an Identifier Resolution (IDR) process 730, linking them to a unique user ID, such as a hashed email or a user token, or any other identifier types. Further, the hashed email or user identifier 740 may be sent via a request to the CMP's API 750 in order to retrieve the user's choice preferences. This request 740 ensures that the user's advertising preferences are checked and ready to be applied. As a next step, the choice signal 110, which encodes the user's advertising preferences, may be retrieved from the CMP's database 760. The stored information in the CMP's database 760 may include user ID tokens, such as a hashed email, and a choice object that contains the user's preferences for IBA, which carries the same information as the choice signal 110. Additionally or alternatively, the choice object may be returned directly to the browser for local storage, such as in a browser storage 770, for later retrieval. This is especially beneficial if the CMP database 760 becomes temporarily unavailable, or the choice signal 110 is not yet synced to the CMP database 760.

In addition to the CMP's API, there is another API, called on-page choice JS API 790, which may work together with the CMP's API 750 in ensuring that the user preferences are requested through the broader ad-serving process. Specifically, the on-page choice JS API 790 may interact with the user's browser and communicates choice-related data with other ad tech parties 140. After the choice signal 110 is retrieved by the CMP's API 750, the on-page choice JS API 790 may allow the choice signal 110 to be requested by ad tech parties 140, such that the advertising choices made by the users can be presented in the broader ad ecosystem, according to the user's choice preferences.

Advantageously, the CMP's API 750 may be an extensible API. In the above illustrated data flow, the CMP's API 750 can accommodate various user identification methods (such as login systems or IDR) and facilitate the transmission of choice preferences across different digital properties within the CMP's own client base. The CMP's API 750 may be capable of handling requests for the choice signal 110, whether returning the data to a central database or directly to a user's browser 770 for local storage. Its flexibility may also extend to communication with other Ad Tech parties 140 via the On-page choice JS API 790, ensuring that the CMP 410 can support the dynamic exchange of information between publishers, ad networks, and data providers. Additionally, the CMP's API 750 may be customized and extended to meet the unique requirements of specific publishers, ad tech platforms, or privacy regulations, enabling enhanced functionality such as supporting new privacy tools or scaling across a larger network of sites and apps. This extensibility ensures that the CMP's API 750 remains adaptable to evolving privacy standards and technologies, while consistently providing users with control over their advertising preferences across different digital environments.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

1. A method comprising:
receiving a user identification (ID) of a user through an activity of the user on a publisher platform, wherein the user ID is a hashed email or a hashed phone number;
transmitting the user ID via a request to an API, wherein the API is an extensible API, and wherein the request includes an identifier-type parameter identifying a type of the user ID, an action parameter specifying a user-selected action relating to targeted advertising, and a preference-string parameter identifying one or more advertising interest categories selected by the user to enable or limit, and wherein the extensible API processes the preference-string parameter using a preference-data handler that is separate from handlers for the identifier-type parameter and the action parameter;
retrieving a choice signal associated with the user ID compiled via the API, wherein the choice signal includes a choice string encoding the one or more choices and/or preferences of the user, wherein the choice string comprises a plurality of sections including a header section and a per-category preference section, wherein the header section includes a version field identifying a version of a choice-signal specification for parsing the choice string, and wherein the per-category preference section includes a category identifier and a category preference value indicating whether advertising in a corresponding advertising interest category is allowed or limited by the user;
receiving a bid request, from the publisher platform, to display an ad to the user by at least one advertiser;
identifying, by the at least one advertiser, the one or more choices and/or preferences of the user by determining, based on the version field, the version of the choice-signal specification for parsing the choice string and parsing, according to the determined version, the per-category preference section to identify the category identifier and the category preference value;
determining a bidding strategy in response to the bid request based on the identification; and
displaying the ad on the publisher platform to the user in accordance with the bidding strategy.

2. The method of claim 1, wherein the one or more choices and/or preferences of the user comprises a first action to:
opt in to receive the ad from the at least one advertiser;
opt out to receive the ad from the at least one advertiser; and
express no preference to receive the ad from the at least one advertiser.

3. The method of claim 1, wherein the one or more choices and/or preference of the user further comprises a second action to:
opt in to receive the ad from at least one ad category;
opt out to receive the ad from the at least one ad category;
express no preference to receive the ad from the at least one ad category.

4. The method of claim 1, wherein the bid request has access to the choice signal.

5. The method of claim 2, wherein the bidding strategy comprises submitting a bid to display the ad from the at least one advertiser upon the identification of the one or more choices and/or preferences of the user comprising the first action to opt in to receive the ad from the at least one advertiser.

6. The method of claim 3, wherein the bidding strategy comprises submitting the bid to display the ad from the at least one ad category upon the identification of the one or more choices and/or preferences of the user comprising the second action to opt in to receive the ad from the at least one ad category.

7. The method of claim 1, wherein the choice signal comprises a plurality of bits and a plurality of sections, wherein each section of the plurality of sections comprises one or more bits of the plurality of bits.

8. The method of claim 7, wherein:
a first section of the plurality of sections represents a version of the user's choice and/or preferences information;
a second section of the plurality of sections represents a timestamp at which the user's choice and/or preferences information was created;
a third section of the plurality of sections represents a global choice by the user for data collection and usage to obtain the user's choice and/or preferences information;
a fourth section of the plurality of sections represents a per-advertiser choice by the users for the at least one advertiser, wherein the fourth section further comprises:
a first sub-section representing a number of the at least one advertiser;
a second sub-section representing an identification of the at least one advertiser;
a third sub-section representing a per-advertiser choice by the user for the at least one advertiser; and
a fifth section of the plurality of sections represents a per-category choice by the user for the at least one ad categories, wherein the fifth section further comprises:
a first sub-section representing a number of the at least ad category;
a second sub-section representing an identification of an interest category of the at least one ad category;
a third sub-section representing a per-category choice by the user for the at least one at category.

9. The method of claim 8, wherein:
the global choice of ‘0’ indicates that the user has explicitly chosen to limit collecting and using the user's choice and/or preferences information;
the global choice of ‘1’ indicates that the user has explicitly chosen to allow collecting and using the user's choice and/or preferences information;
the global choice of ‘2’ indicates that the user has explicitly expressed no preference for collecting and using the user's choice and/or preferences information, wherein the fourth section is non-empty only if the global choice equals to 2.

10. A method comprising:
detecting an activity of a user on a publisher platform using a browser, wherein the browser comprises a choice extension having a local database that stores a choice signal associated with the browser, the choice signal indicating one or more choices and/or preferences of the user, and wherein the choice extension is configured to make the stored choice signal available at a browser level when the browser accesses the publisher platform;
retrieving, from the local database of the choice extension in response to the activity, the choice signal associated with the browser from the local database through the choice extension;
receiving a bid request, from the publisher platform, to display an ad to the user by at least one advertiser, wherein the bid request has access to the choice signal retrieved through the choice extension;
identifying, by the at least one advertiser, the one or more choices and/or preferences of the user based on the choice signal;
determining a bidding strategy in response to the bid request based on the identification; and
displaying the ad on the publisher platform to the user in accordance with the bidding strategy.

11. The method of claim 10, wherein the one or more choices and/or preferences of the user comprises a first action to:
opt in to receive the ad;
opt out to receive the ad; and
express no preference to receive the ad from the at least one advertiser.

12. The method of claim 10, wherein the one or more choices and/or preference of the user further comprises a second action to:
opt in to receive the ad;
opt out to receive the ad;
express no preference to receive the ad from the at least one ad category.

13. The method of claim 11, wherein the bidding strategy comprises submitting a bid to display the ad from the at least one advertiser upon the identification of the one or more choices and/or preferences of the user comprising the first action to opt in to receive the ad from the at least one advertiser.

14. The method of claim 12, wherein the bidding strategy comprises submitting the bid to display the ad from the at least one ad category upon the identification of the one or more choices and/or preferences of the user comprising the second action to opt in to receive the ad from the at least one ad category.

15. The method of claim 10, wherein the choice signal comprises a plurality of bits and a plurality of sections, wherein each section of the plurality of sections comprises one or more bits of the plurality of bits.

16. The method of claim 15, wherein:
a first section of the plurality of sections represents a version of the user's choice and/or preferences information;
a second section of the plurality of sections represents a timestamp at which the user's choice and/or preferences information was created;
a third section of the plurality of sections represents a global choice by the user for data collection and usage to obtain the user's choice and/or preferences information;
a fourth section of the plurality of sections represents a per-advertiser choice by the users for the at least one advertiser, wherein the fourth section further comprises:
a first sub-section representing a number of the at least one advertiser;
a second sub-section representing an identification of the at least one advertiser;
a third sub-section representing a per-advertiser choice by the user for the at least one advertiser; and
a fifth section of the plurality of sections represents a per-category choice by the user for the at least one ad categories, wherein the fifth section further comprises:
a first sub-section representing a number of the at least ad category;
a second sub-section representing an identification of an interest category of the at least one ad category;
a third sub-section representing a per-category choice by the user for the at least one at category.

17. The method of claim 16, wherein:
the global choice of ‘0’ indicates that the user has explicitly chosen to limit collecting and using the user's choice and/or preferences information;
the global choice of ‘1’ indicates that the user has explicitly chosen to allow collecting and using the user's choice and/or preferences information;
the global choice of ‘2’ indicates that the user has explicitly expressed no preference for collecting and using the user's choice and/or preferences information, wherein the fourth section is non-empty only if the global choice equals to 2.

18. A method comprising:
receiving one or more choices and/or preferences related to advertisement from a user;
compiling, via an extensible API associated with a first system, the one or more choices and/preferences into a choice signal, wherein the choice signal comprises an opt-in action for a first advertiser and an opt-out action for a second advertiser;
storing the choice signal in a first data store associated with the first system;
storing. in a second data store associated with a browser used to access the publisher platform. a choice object corresponding to the choice signal;
receiving a user identification (ID) of the user through an activity of the user on the publisher platform;
attempting to retrieve the choice signal associated with the user ID from the first store;
determining that the choice signal is unavailable from the first data store;
in response to the determining, retrieving the choice object from the second data store;
transmitting the choice object to an ad tech party, wherein the ad tech party blocks the second advertiser based on the opt-out action of the choice signal.

19. The method of claim 18, wherein the choice signal comprises a plurality of bits and a plurality of sections, wherein each section of the plurality of sections comprises one or more bits of the plurality of bits.

20. The method of claim 19, wherein:
a first section of the plurality of sections represents a version of the user's choice and/or preferences information;
a second section of the plurality of sections represents a timestamp at which the user's choice and/or preferences information was created;
a third section of the plurality of sections represents a global choice by the user for data collection and usage to obtain the user's choice and/or preferences information;
a fourth section of the plurality of sections represents a per-advertiser choice by the users for the at least one advertiser, wherein the fourth section further comprises:
a first sub-section representing a number of the at least one advertiser;
a second sub-section representing an identification of the at least one advertiser;
a third sub-section representing a per-advertiser choice by the user for the at least one advertiser; and
a fifth section of the plurality of sections represents a per-category choice by the user for the at least one ad categories, wherein the fifth section further comprises:
a first sub-section representing a number of the at least ad category;
a second sub-section representing an identification of an interest category of the at least one ad category;
a third sub-section representing a per-category choice by the user for the at least one at category.

21. The method of claim 10, wherein retrieving the choice signal comprises retrieving the choice signal through a JavaScript API, an HTTP header, interrogation of the choice extension, or an event listener exposed by the choice extension on a webpage accessed by the browser.

22. The method of claim 10, wherein the browser-associated choice signal comprises at least one of a global interest-based-advertising choice status, a per-advertiser choice status, or a per-category advertising preference.

23. The method of claim 1, wherein the extensible API is configured to process an additional request parameter as a non-breaking addition while maintaining processing of the identifier-type parameter, the action parameter, and the preference-string parameter.

24. The method of claim 1, wherein the preference-string parameter is configured to identify advertising interest categories according to one of a plurality of category taxonomies.

25. The method of claim 10, wherein the choice signal communicated by the choice extension does not include a personal identifier of the user.

26. The method of claim 18, wherein the choice signal further represents one or more additional advertising-choice actions for at least one additional advertiser or at least one advertising category.
